(19) United States
(12) Patent Application Publication
(10) Pub. No.: US 2007/0019874 A1
(43) Pub. Date: Jan. 25, 2007

(54) Method and apparatus for scalable signal processing

(75) Inventors: Ramanathan Sethuraman, Eindhoven (NL); Fabian Edgar Ernst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/570,546

(22) PCT Filed: Aug. 26, 2004
(86) PCT No.: PCT/IB04/51573

§ 371 Date: Mar. 3, 2006

(30) Foreign Application Priority Data
Sep. 12, 2003 (EP) 03103373.1

(51) Int. Cl. G06K 9/36

(52) U.S. Cl. 382/239

(57) ABSTRACT

The invention relates to content signal processing and in particular to processing of a video content signal. An apparatus (100) for content signal processing comprises a scalable encoder (101) for encoding a content signal to generate scalable encoded data comprising data associated with a plurality of compression rates. A compression processor (105) determines compression factor indicators indicating data associated with the plurality of compression rates. Thus, the compression factor indicators indicate which data of the scalable encoded data corresponds to the different compression rates. Combined data comprising the scalable encoded data and the compression factor indicators are stored in a frame memory (105). An application having a given compression factor requirement may use the compression factor indicators to access the scalable encoded data of the frame memory (105) which is required for processing. A plurality of applications may access the same frame memory (105) thereby allowing for scalable encoded data which can be used with a plurality of applications having different compression factor requirements.

### FIELD OF THE INVENTION

The invention relates to a method and apparatus for content signal processing and in particular for processing a scalable encoded signal.

### BACKGROUND OF THE INVENTION

In recent years, the use of digital storage and distribution of content signals such as video signals have become increasingly prevalent. Accordingly, a large number of different encoding techniques for different content signals have been developed. For example, a number of video encoding standards have been designed to facilitate the adoption of digital video in many professional- and consumer applications and to ensure compatibility of equipment from different manufacturers.

Most influential standards are traditionally developed by either the International Telecommunications Union (ITU-T) or the MPEG (Motion Pictures Experts Group) committee of the ISO/IEC (the International Organization for Standardization/the International Electrotechnical Committee).The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB) standard). Currently, one of the most widely used video compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero. For compression of chrominance data, the amount of chrominance data is usually first reduced by down-sampling, such that for each four luminance blocks, two chrominance blocks are obtained (4:2:0 format), that are similarly compressed using the DCT and quantization. Frames based only on intra-frame compression are known as Intra Frames (I-Frames).

It is desirable to reduce the resulting encoding rate as much as possible in order to reduce the bandwidth required to transmit video signals as well as the memory required for storage of video signals.

In recent years a large number of different video applications and processes have been developed which are aimed at processing of digital video. These applications include for example algorithms for video encoding and compression in accordance with the developed video standards but also extend to a number of algorithms for processing of video signals in order to derive additional information or provide additional effects. For example, applications for content analysis or three-dimensional information extraction have been developed.

In order to efficiently implement these algorithms and applications, many dedicated or semi-dedicated integrated circuits are being developed. As many of the developed algorithms are based on one or more frames of the video signals, the video processing circuitry comprise frame memory which holds the data of one or more frames. Preferably, the frame memory is embedded on the same chip as the processing functionality as this allows for faster data transfers, increased bandwidth and reduced power consumption.

However, as the chip size of an integrated circuit is limited, the frame memory embedded is typically limited and may further vary between different integrated circuits. Additionally, in some applications, the frame memory may be external which allows it to be significantly larger than for embedded frame memory.

Accordingly, scalable embedded compression techniques have been developed which allows for a frame of a video signal to be encoded in a format where it can be scaled to suit a given frame memory. Thus, a non-compressed frame may for example comprise 10 Mbits. If the frame memory is only 2 Mbits, a scalable compression algorithm allows for the 10 Mbit of data to be compressed to 2 Mbits. However, if the frame memory allows only 1 Mbit of data, the algorithm may compress the frame to 1 Mbit. Thus the frame may be encoded into frame memory such that it fits the available memory capacity.

One such encoding algorithm is described in “DCT-domain embedded memory compression for hybrid video coders” by R. P. Kleihorst and R. J. van der Vleuten, Journal of VLSI Signal Processing Systems, vol. 24, pp 1523-1543, 2000, Institute of Electrical and Electronic Engineers. This allows for an efficient storage of frame data of a video signal.

The technique described by Kleihorst et al. provides for an efficient scalable embedded encoding which is suited for a given application. Thus, one or more frames may be encoded and stored in frame memory. The frames may then be provided to the application and processed by this. However, currently many video signal processing techniques are known and may be applied to video signals. Accordingly, a video signal may be used for several different processes and applications. For example, an encoded signal may be processed to generate three dimensional information from two-dimensional pictures; to be compressed to a lower data rate or may be processed to derive content information. However, many of these applications or processes have different characteristics and require different parameters of the input video signal. For example, segmentation processes may be based on frame signals which are compressed by up to a factor of eight whereas a compression algorithm may require that the input video signal is compressed by a factor of four or less. Thus, as different applications have different requirements, the technique described by Kleihorst et al. is not directly applicable and requires that frame data is converted into a format suitable for the different applications having different requirements.

Hence, an improved method and apparatus for content signal processing would be advantageous and in particular a system facilitating the use of scalable embedded encoded signals with different applications or processes would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided an apparatus for content signal processing comprising: encoding means for encoding a content signal to generate scalable encoded data comprising data associated with a plurality of compression rates; means for determining compression factor indicators indicating data associated with the plurality of compression rates; and means for generating combined data comprising the scalable encoded data and the compression factor indicators. The content signal may be a video signal.

The invention allows for scalable encoded data to be generated which may be used with a number of different applications having different requirements. In particular, scalable encoded data may be generated from which data corresponding. to a desired or required compression factor may be extracted. The compression factor indicators indicate data associated with different compression rates. The invention allows for data corresponding to a given compression factor to be extracted directly by use of the compression factor indicators.

The compression factor indicators may preferably include a multiplicity of indicators indicating the data corresponding to a given compression factor in a multiplicity of blocks. For example, the scalable encoding may be based on grouping content data into groups of content data and encoding each group individually. Preferably, a set of compression factor indicators is generated for each group. For a video content signal, each group of data may for example correspond to a Discrete Cosine Transform (DCT) block. The compression factor indicators may differ between blocks as may the criteria used for determining the compression factor indicators. For example, the algorithm for determining the compression factor indicators may depend on characteristics of the individual groups or blocks of data.

The combined data may for example be stored in a suitable data store or may be communicated to an internal or external application. Preferably, the data associated with a plurality of compression rates comprises overlapping sets of data. Hence, a data section which corresponds to a given compression factor is preferably a subset of a data section corresponding to a lower compression factor. For example, if the encoding uses a DCT each compression factor may correspond to a given truncation of the generated spatial frequency coefficients with increasing compression factors corresponding to increasing truncations.

Hence, the invention may allow for combined data to be generated which facilitates use of scalable encoded data to be used for different applications having different compression factors.

The term compression factor may include indirect references to compression factors such as a resulting data rate, frame memory size, compression rate or similar.

According to a feature of the invention, the apparatus further comprises first processing means for processing a first application, the first processing means comprising: means for determining at least a first compression factor associated with the first application; first extraction means for extracting a first data set associated with the first compression factor of the scalable encoded data in response to the compression factor indicators; means for processing the scalable encoded data in accordance with the first application.

The invention thus allows for a given application to extract the required or desired data from a scalable encoded signal. Hence, the invention allows for a low complexity and/or flexible way of distributing data which may be customised by the individual application to suit the requirements of this application. This furthermore allows for a high degree of flexibility in the design and updating of applications since processes or algorithms utilising different compression factors can be introduced without requiring any changes to the encoding of the content signal.

The determination of the at least first compression factor may be an active determination in response to an evaluation of one or more varying characteristics of e.g. the content signal, the scalable encoded data or the application. Alternatively or additionally it may be a passive determination such as simply using a predetermined value for the first application. Preferably a plurality of compression factors is determined and data is extracted in response to these compression factors. For example, a different compression factor may be generated for different sections or data groups of the scalable encoded data or of the underlying content signal.

According to a different feature of the invention, the first application is a segmentation application. This allows for an efficient and flexible way of performing a segmentation operation on an encoded content signal.

According to a different feature of the invention, the first extraction means is operable to extract the first data set in response to a segmentation determined by the first application. This allows for data to be extracted which specifically suit the characteristics of different segments determined by the segmentation application. Thus the process may advantageously include a feedback loop wherein the segmentation is based on the extraction of data and the extraction of data being refined in view of the segmentation. For example, increased compression factors may be used within homogenous segments and lower compression factors may be used between segments or within non-homogeneous sectors. Thus, the compression factors and data to process may be optimised or improved for the characteristics of the scalable encoded data or content signal thus allowing for a more efficient processing with reduced resource requirements. This is particularly advantageous for a time consistent segmentation wherein segmentation information of previous data applies to the current data For example, segmentation of a previous video frame may be used for extraction of a first data set of a subsequent video frame.

According to a different feature of the invention, the apparatus further comprises second processing means for processing a second application, the second processing means comprising: means for determining a second compression factor associated with the second application; the second compression factor being different than the first compression factor;

second extraction means for extracting a second data set associated with the second compression factor of the scalable encoded data in response to the compression factor indicators; and means for processing the scalable encoded data in accordance with the second application.

Thus the invention allows for a single scalable encoded data signal to be used for a plurality of applications having different requirements and specifically having different associated compression factors. The associated compression factors may vary for different sections or groups of the scalable encoded data or the underlying content signal. The compression factors may be identical in some sections while differing in other sectors. For example, the ranges of the different compression factors may be different for the first and second application. Hence, the invention allows for a very flexible scalable encoded data and for a flexible and efficient encoding and processing system for content signals.

The means for extracting data may be different means or may be the same means extracting data in response to the compression factors of the first or the second application.

According to a different feature of the invention, the first extraction means is operable to send data of the first data set associated with the second compression factor to the second processing means; and the second extraction means is operable to extract additional data associated with the second compression factor.

This provides for an efficient and easy to implement means of extracting data for a plurality of applications. Specifically, this may provide for a fast and low complexity way of extracting data for two applications where one set of data is a subset of the other. For example, if the second application requires data according to a lower compression factor than the first application, this may require that the second application is supplied with the data provided to the first application plus further data associated with the lower compression factor. In this approach, only one extraction operation is required for each data element even if needed by both applications.

According to a different feature of the invention, the second application is a compression application. This allows for an efficient and flexible way of performing a compression operation on an encoded content signal.

According to a different feature of the invention, the second processing means comprises a data storage for storing the second data set and wherein the second application is operable to store compressed data in the data storage and comprises a compression algorithm operable to perform compression in response to the stored compressed data.

This allows for an efficient compression of a content signal wherein the compression may be based on past compressed data. For example, for a video content signal, compression of a given frame may be in response to other compressed frames.

According to a different feature of the invention, the first application is a segmentation application and the first processing means is operable to provide segmentation data of the segmentation application to the second processing means and the compression application is operable to perform compression in response to the segmentation data. This allows for the compression to be in response to a segmentation thereby allowing for an efficient compression with improved quality and/or compression rates. For example, segments comprising homogenous data may be compressed with higher compression factors than segment transitions or segments comprising non-homogenous data. Hence the invention allows for a flexible, efficient and/or high performance way of combining a segmentation algorithm and a compression algorithm.

According to a different feature of the invention, the first data set corresponds to a frame of the scalable encoded data and the first extraction means (201) is operable to extract the first data set in response to a segmentation of the frame. For example, an external segmentation process may provide segmentation information that can be used for optimising the extraction of data This allows for improved data extraction based on only on spatial information and analysis and not requiring temporal information.

According to a different feature of the invention, the encoding means comprise a single pass scalable encoder. The invention allows for a single pass encoder to generate scalable encoded data which can be used directly by a plurality of applications having different compression factor requirements. Thus, the requirement for multiple pass encoding may be obviated or mitigated by the invention. Hence, the complexity, computational resource, cost and/or speed of encoding may be significantly reduced.

According to a different feature of the invention, the compression factor indicators comprise at least one pointer indicating a termination point and/or a starting point for data associated with a given compression factor. This provides for a particularly advantageous way of indicating data associated with the given compression factor. It allows for simple implementation and simple extraction of data.

According to a different feature of the invention, the content signal is a video signal. The invention allows for an advantageous way of generating scalable encoded data for a video signal which may be directly used by a plurality of video processing applications having different requirements of the scalable encoded data.

According to a second aspect of the invention, there is provided an apparatus for content signal processing comprising: receiving means for receiving combined content signal data comprising scalable encoded data comprising data associated with a plurality of compression rates and compression factor indicators indicating data associated with the plurality of compression rates; means for determining at least a first compression factor associated with a first application; extraction means for extracting a first data set associated with the first compression factor of the scalable encoded data in response to the compression factor indicators; and means for processing the first data set in accordance with the first application.

According to a third aspect of the invention, there is provided a method of content signal processing comprising the steps of: encoding a content signal to generate scalable encoded data comprising data associated with a plurality of compression rates; determining compression factor indicators indicating data associated with the plurality of compression rates; and generating combined data comprising the scalable encoded data and the compression factor indicators.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates an apparatus for content signal processing in accordance with an embodiment of the invention; and

FIG. 2 illustrates an apparatus for processing a plurality of applications in accordance with an embodiment of the invention

### DESCRIPTION OF PREFERRED EMBODIMENTS

The following description focuses on an embodiment of the invention applicable to processing of a video signal but it will be appreciated that the invention is not limited to this application but may be applied to many other content signals including for example audio or multimedia content signals.

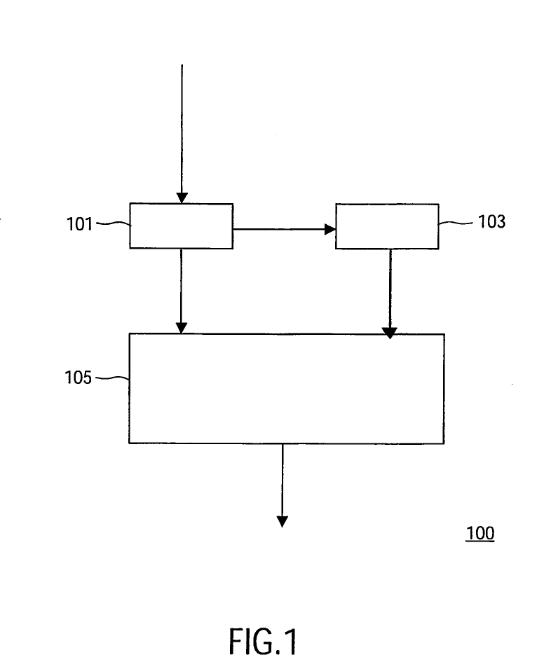

FIG. 1 illustrates an apparatus 100 for content signal processing in accordance with a preferred embodiment of the invention.

The apparatus 100 comprises a scalable encoder 101 which receives a video signal from a suitable source (not shown) which may be an internal or external source. In the preferred embodiment, the received video signal is a raw digitised video signal which has not been encoded or compressed. In other embodiments, the video signal may already have been encoded and/or compressed in a suitable format.

The scalable encoder 101 is operable to encode the received video signal such that it can fit into a given frame memory size. The scalable encoder 101 of the preferred embodiment uses the algorithm described in “DCT-domain embedded memory compression for hybrid video coders” by R. P. Kleihorst and R. J. van der Vleuten, Journal of VLSI Signal Processing Systems, vol. 24, pp 1523-1543, 2000, Institute of Electrical and Electronic Engineers.

The scalable encoder 101 thus produces a signal which can be scaled to fit into a given memory allocation. Specifically, the scalable encoder 101 divides a frame of the received video signal into a number of 8 by 8 pixel blocks. A Discrete Fourier Transform (DCT) is performed on each block to generate spatial frequency coefficients. A number of frequency coefficients are selected and encoded bitplane by bitplane (i.e. first all most significant bits of all selected coefficients are included, then the next most significant bit of all selected coefficients and so on).

In the preferred embodiment, the video signal is stored in a frame memory 103 coupled to the scalable encoder 101. In the preferred embodiment, the frame memory stores one or more frames in the DCT domain, i.e. the selected coefficients of each DCT block are stored in bitplane order. Furthermore, in the preferred embodiment, the scalable encoder 101 is operable to scale the DCT encoded signal to fit the frame memory 103 partly by selecting an appropriate number of coefficients and partly by truncating the word size for different coefficients.

Thus, preferably, the scalable encoder 101 selects a number of low frequency coefficients and rejects a number of high frequency coefficients for each DCT block The number of high frequency coefficients that are rejected depends on the available memory capacity of the frame memory. Additionally or alternatively, the scalable encoder 101 may truncate some of the least significant bits from some or all of the coefficients depending on the available memory capacity. This allows for a compressed video signal which suits the frame memory. In the preferred embodiment, the scalable encoder 101 uses the full available capacity of the frame memory 103 regardless of the requirements of the intended application. Thus, even if an application is based on a compression factor of four, the scalable encoder 101 stores data corresponding to a compression factor of two provided the frame memory has sufficient capacity.

In the preferred embodiment, the data stored in the frame memory 105 thus corresponds to a plurality of compression rates. Specifically, the selection of the DCT coefficients and word sizes correspond to a first compression rate. However, if fewer DCT coefficients and/or reduced word sizes are chosen, a higher compression rate could be achieved. Thus, the data stored in the frame memory 105 comprises a subset of data which corresponds to a higher compression factor. Accordingly, depending on which data is extracted from the frame memory 105, signals with different compression factors or rates can be obtained.

The scalable encoder 101 is further coupled to a compression processor 105. The compression processor 105 is operable to determine compression factor indicators which indicate data associated with the plurality of compression rates.

In the preferred embodiment, the compression processor 105 determines a number of compression factor indicators corresponding to a plurality of fixed compression factors or equivalently to a number of equivalent frame sizes or data rates. For example, the compression processor 105 may determine compression factor indicators for a compression factor of 2, 4, 6 and 8. For each of these compression factors, compression factor indicators are determined that identify the data of the frame memory 105 which should be extracted to generate a video signal having the desired compression factor.

It will be appreciated that the term compression factor may include indirect references to compression factors such as a resulting data rate, frame memory size, compression rate or similar.

In the preferred embodiment, the compression factor indicators comprise pointers which point to the start point and termination point for data of each compression factor. Thus, specifically, the scalable encoded data of the scalable encoder 101 corresponds to a minimum compression factor achieved by including all data of the frame memory 105. For each higher compression factor, the compression processor 105 determines which data should be included to achieve this compression factor. Specifically, it determines which DCT coefficients should be included and the word sizes of the selected coefficients. It then generates pointers for each block indicating the start and termination point of this data Depending on the organisation and data structure in the frame memory 105, a plurality of start and termination pointers may be generated for each DCT block. When all compression factor indicators are determined for one compression factor, the compression processor 105 proceeds to determine pointers for the next higher compression factor.

As higher compression factors in the preferred embodiment are achieved by increasing truncation of high frequency coefficients and least significant bits, the higher compression factors are achieved by identifying a subset of the scalable encoded data selected by a lower compression factor. Thus, the data comprises data sets which are nested within each other such that higher compression factors are subsets of the lower compression factors. This may be used in reducing the number of compression factor indicators needed since compression factor indicators indicating data of the higher compression factors may also be used for lower compression factors.

The compression processor 105 is coupled to the frame memory 105 and is operable to store the compression factor indicators therein. Thus, the frame memory 105 comprises combined data comprising both the scalable encoded data from the scalable encoder 101 and the compression factor indicators from the compression processor 105.

It will be appreciated that in some embodiments, no frame memory 105 is used and the scalable encoded data and the compression factor indicators are combined for example by being included in a signal that may be distributed to other functional units.

Accordingly, the apparatus 100 allows for combined data to be generated that can be scaled to suit a given limitation, such as a given memory allocation, and which can be used to derive data signals having different compression rates. For example, an application may extract data from a frame memory 105 in accordance with a compression factor of four whereas another application may extract data from the frame memory in accordance with a compression factor of e.g. eight. No change is required in the scalable encoder 101 or the compression processor 105 or the stored scalable encoded data for this to be achieved. Rather, the application may simply extract the required data. Indeed the two applications may extract data corresponding to different compression factors (and thus data rates etc.) substantially simultaneously. Hence, the embodiment allows for a very flexible and efficient system that allows different applications with different requirements to use the same single pass encoding and the same scalable encoded data generated by that decoding.

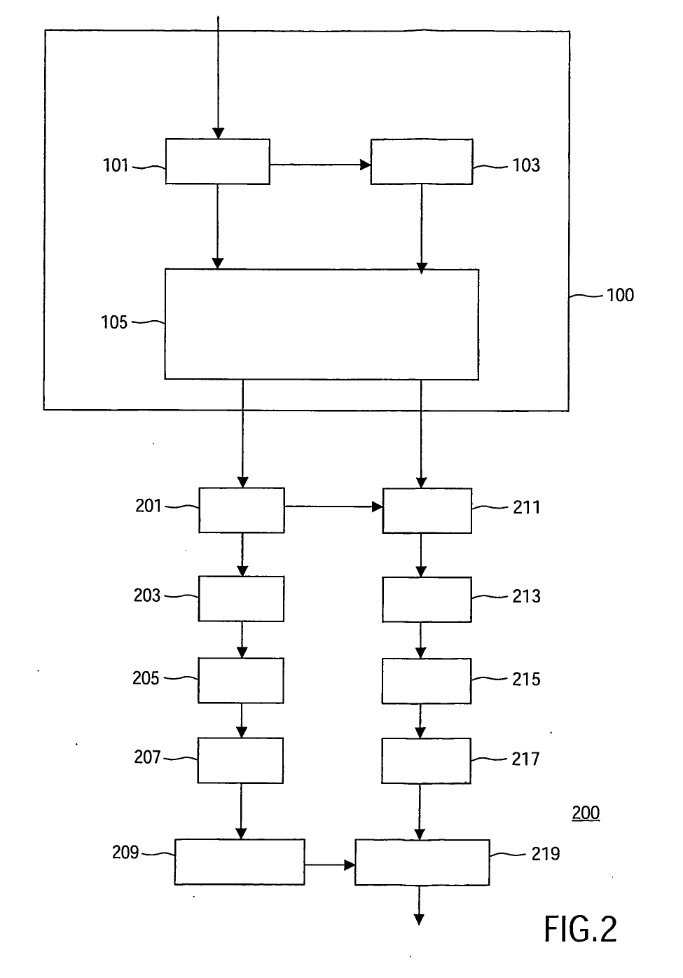

FIG. 2 illustrates an apparatus 200 for processing a plurality of applications in accordance with a preferred embodiment of the invention. The apparatus incorporates the apparatus 100 of FIG. 1, and identical functional modules are indicated by identical reference signs.

The apparatus 200 comprises a first extraction processor 201 which is operable to determine a first compression factor associated with a first application. In the preferred embodiment, the first compression factor is simply determined as a pre-stored value for the given application, but in other embodiments, the first extraction processor 201 is operable to determine the first application by analysing characteristics of the application or the content signal. For example, the first extraction processor 201 may comprise communication circuitry capable of exchanging this information with the application.

The first extraction processor 201 is furthermore operable to extract a first data set from the scalable encoded data which corresponds to the determined first compression factor. In the preferred embodiment, the first extraction processor 201 is coupled to a first cache memory 203 where the first data set may be temporarily stored. Thus, in the preferred embodiment, the first extraction processor 201 determines a compression factor for the stored frame in the frame memory 105 which is suitable for a first application. The first extraction processor 201 then extracts the compression factor indicators corresponding to the first compression factor and subsequently extracts all data from the frame memory 105 which is indicated by the compression factor indicators to correspond to the first compression factor. Following this operation, the first cache memory 203 comprises a frame of the video signal having a data size corresponding to the first compression factor.

The first cache memory 203 is coupled to a first decoder 205 which is operable to convert the data of the frame stored in the first cache memory 203 into a suitable frame format for the subsequent processing by the application. Specifically, the first decoder 205 may perform an Inverse Discrete Cosine Transform (IDCT) to convert the DCT block data back into the spatial domain. However, the exact nature of the decoding will depend on the requirements of the subsequent processing by the first application. Specifically, in some embodiments, the frame data from the frame memory 105 may be used directly without any intervening conversion.

The first decoder 205 is coupled to a second cache memory 207 and the converted data is temporarily stored therein.

The second cache memory 207 is coupled to a first application processor 209 which is operable to process the converted data set in accordance with the first application. It will be appreciated, that the first application may be any suitable application. However, in the preferred embodiment the first application is a segmentation application which divides the frame into a number of different image segments in accordance with predefined criteria

Specifically, the segmentation application is preferably a time consistent pixel precise segmentation algorithm which is capable of dividing the frame into image segments which have homogenous visual characteristics such as a similar colour or texture. Segmentation of frames is a complex process which may provide useful data for other applications including for example object recognition or video compression applications.

In the preferred embodiment, the segmentation output is further used by the first extraction processor 201 in extracting the first data set. Thus, in the preferred embodiment, the first application processor 209 is coupled to the first extraction processor 201 such that the segmentation data generated by the first application processor 209 is fed back to the first extraction processor 201. The first extraction processor 201 may then determine compression factors which vary across a frame depending on the segmentation data. This is particularly useful for time consistent segmentation wherein the segmentation of a given frame may be applicable to a subsequent frame. For example, motion estimation of segments may be used to determine segmentation information for a subsequent frame. Hence, time consistent past information may be used in the extraction.

For example, a higher compression factor is determined for data blocks which are wholly comprised within an image segment having homogenous characteristics such as substantially the same colour without significant texture. A lower compression factor may be determined for blocks in image segments which have high levels of texture or overlap edges between different image segments. Hence, the compression factors may be dynamically adjusted to correspond to the visual impact of increasing the compression and accordingly improved processing results may be achieved.

In other embodiments, an external segmentation process may be used. For example, a given frame held in the frame memory may be analysed independently and the derived segmentation information may be used to extract the first data set. This allows for an improved data extraction based only on a spatial segmentation and does not necessitated time consistent segmentation or temporal correlation.

The apparatus of the preferred embodiment is furthermore capable of processing a second application and is specifically capable of processing the second application simultaneously with the first application.

In the preferred embodiment, the apparatus further comprises a second extraction processor 211 which is operable to determine a second compression factor which is associated with the second application. The second compression factor is in the preferred embodiment different than the first compression factor.

It will be appreciated that the description for clarity and brevity refers to a first and second compression factor but that this may include a plurality of compression factors or ranges or intervals of compression factors. Furthermore, the first and second compression factor may comprise overlapping ranges of compression factors which preferably are not overlapping. For example, the first application may be based on compression factors of 4, 6 and 8 and the first extraction processor 201 may extract data corresponding to one of these compression factors depending on e.g. the characteristics of an individual DCT block. Similarly, the second application may be based on compression factors of 2, 4, 6 and 8, and data may be extracted corresponding to one of these compression factors depending on e.g. the characteristics of the individual DCT block. Hence, the compression factors of the first and second application may be similar or identical for some DCT blocks and different for other DCT blocks.

The second extraction processor 211 is furthermore operable to extract a second data set from the frame memory 105 in response to the second compression factor.

In the preferred embodiment, the second extraction processor 211 is coupled to the first extraction processor 201 and is operable to receive data directly from this. In this embodiment, the second extraction processor 211 receives the common data of the first and second data set directly from the first extraction processor 201. Specifically, the compression factor of the second application may correspond to a lower compression factor than the first compression factor and the first data set may be a subset of the second data set. Therefore, the second extraction processor 211 receives the first data set directly from the first extraction processor 201. In addition, the second extraction processor 211 is coupled directly to the frame memory 105 and extracts additional data therefrom. Thus, in this embodiment the second extraction processor 211 directly extracts the data of the second data set which has not been received from the first extraction processor 201 from the frame memory 105.

Similarly, if the second data set is a subset of the first data set, the second extraction processor 211 may simply receive the subset of data from the first extraction processor 201 or may receive the entire first data set and discard the data which is not required.

Thus, the second extraction processor 211 may extract data from the frame memory 105 through the first extraction processor 201. In particular the first extraction processor 201 and the second extraction processor 211 may be the same functional module or unit.

Providing data to the second extraction processor 211 through the first extraction processor 201 is particularly advantageous in situations where the apparatus 100 of FIG. 1 is implemented by external units whereas the remaining functional modules are implemented on a single integrated circuit. Thus, in embodiments employing a large frame memory, this may be implemented by off-chip external memory and the access of the external memory may be minimised. Hence, the implications of the bandwidth limitation and delay associated with accessing external memory may be reduced.

The apparatus 200 further comprises a third cache memory 213, equivalent to the first cache memory 203, and allowing for a temporary storage of the second data set. The second cache memory 213 is coupled to a second decoder 215 which is operable to convert the data of the frame stored in the third cache memory 213 into a suitable frame format for the second application. The performance of the second decoder 215 is in the preferred embodiment equivalent to that of the first decoder 205 and will therefore not be described in further detail. The second decoder 215 is coupled to a fourth cache memory 217 and the converted data is temporarily stored therein.

The fourth cache memory 217 is coupled to a second application processor 219 which is operable to process the converted data set in accordance with a second application. It will be appreciated that the second application may be any suitable application. However, in the preferred embodiment, the second application is a video encoding/compression application which is operable to encode the video signal into a digital video signal in accordance with a defined standard such as MPEG2.

Methods and algorithms for encoding a video signal in accordance with e.g. the MPEG2 standard are well known in the art and will not be described in further detail.

In some embodiments, the first and second application are capable of interacting and specifically segmentation data of the first application may be fed to the second application and used in the video compression algorithm. This allows for a compression to be dynamically optimised for the different identified image segments. Thus a high compression may be used for homogenous segments having little texture whereas less compression is used for segments having high texture levels and/or areas associated with borders between segments. Furthermore, the segmentation data may be used for object detection and for motion estimation.

In the preferred embodiment, the second application processor 219 is additionally coupled to the fourth cache memory 217 and is operable to store the compressed video data therein. Thus, the compressed data frames may be stored and used for compression of subsequent frames thereby facilitating motion estimation, object tracking and other video compression techniques.

In the preferred embodiment, most or all functional elements are implemented in a single integrated circuit. Thus, in the preferred embodiment the frame memory and even the scalable encoder 101 and the compression processor 105 are embedded on the same integrated circuit as the remaining processing functionality. However, in other embodiments other distributions are possible and specifically the interface between on-chip and off-chip functionality may be at the input to or the output from the frame memory.

The invention can be implemented in any suitable form including hardware, software, firmware or any combination of these. However, preferably, the invention is implemented at least partly as a dedicated integrated circuit or computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. In addition, singular references do not exclude a plurality. Thus references to “a”, “an”, “first”, “second” etc do not preclude a plurality.

1. An apparatus (100) for content signal processing comprising:
encoding means (101) for encoding a content signal to generate scalable encoded data comprising data associated with a plurality of compression rates;
means (103) for determining compression factor indicators indicating data associated with the plurality of compression rates; and
means (105) for generating combined data comprising the scalable encoded data and the compression factor indicators.

2. An apparatus as claimed in claim 1 further comprising:
first processing means for processing a first application, the first processing means comprising;
means (201) for determining at least a first compression factor associated with the first application;
first extraction means (201) for extracting a first data set associated with the first compression factor of the scalable encoded data in response to the compression factor indicators;
means (203, 205, 207, 209) for processing the scalable encoded data in accordance with the first application.

3. An apparatus as claimed in claim 2 wherein the first application is a segmentation application.

4. An apparatus as claimed in claim 3 wherein first extraction means (201) is operable to extract the first data set in response to a segmentation determined by the first application.

5. An apparatus as claimed in claim 2 further comprising second processing means for processing a second application, the second processing means comprising:
means (211) for determining a second compression factor associated with the second application; the second compression factor being different than the first compression factor;
second extraction means (211) for extracting a second data set associated with the second compression factor of the scalable encoded data in response to the compression factor indicators; and
means (203,205, 207, 209) for processing the scalable encoded data in accordance with the second application.

6. An apparatus as claimed in claim 5 wherein the first extraction means (201) is operable to send data of the first data set associated with the second compression factor to the second processing means and the second extraction means (211) is operable to extract additional data associated with the second compression factor.

7. An apparatus as claimed in claim 5 wherein the first extraction means (201) is operable to send data of the first data set associated with the second compression factor to the second processing means and the second extraction means (211) is operable to discard data not associated with the second compression factor.

8. An apparatus as claimed in claim 5 wherein the second application is a compression application.

9. An apparatus as claimed in claim 5 wherein the second processing means (211) comprises a data storage (213, 217) for storing the second data set; and wherein the second application is operable to store compressed data in the data storage and comprises a compression algorithm operable to perform compression in response to the stored compressed data.

10. An apparatus as claimed in claim 5 wherein the first application is a segmentation application and the first processing means is operable to provide segmentation data of the segmentation application to the second processing means and the compression application is operable to perform compression in response to the segmentation data.

11. An apparatus as claimed in claim 2 wherein the first data set corresponds to a frame of the scalable encoded data and the first extraction means (201) is operable to extract the first data set in response to a segmentation of the frame.

12. An apparatus as claimed in claim 1 wherein the encoding means (101) comprise a single pass scalable encoder.

13. An apparatus as claimed in claim 1 wherein the compression factor indicators comprise at least one pointer indicating a termination point for data associated with a given compression factor.

14. An apparatus as claimed in claim 1 wherein the compression factor indicators comprise at least one pointer indicating a start point for data associated with a given compression factor.

15. An apparatus for content signal processing comprising:
receiving means (201) for receiving combined content signal data comprising scalable encoded data comprising data associated with a plurality of compression rates and compression factor indicators indicating data associated with the plurality of compression rates;
means (201) for determining at least a first compression factor associated with a first application;
extraction means (201) for extracting a first data set associated with the first compression factor of the scalable encoded data in response to the compression factor indicators; and
means (203,205, 207, 209) for processing the first data set in accordance with the first application.

16. A method of content signal processing comprising the steps of:
encoding a content signal to generate scalable encoded data comprising data associated with a plurality of compression rates;
determining compression factor indicators indicating data associated with the plurality of compression rates; and
generating combined data comprising the scalable encoded data and the compression factor indicators.

17. A method as claimed in claim 16 further comprising the steps of:
determining at least a first compression factor associated with the first application;
extracting a first data set associated with the first compression factor of the scalable encoded data in response to the compression factor indicators;
processing the scalable encoded data in accordance with the first application.

18. A computer program enabling the carrying out of a method according to claim 17.

19. A record carrier comprising a computer program as claimed in claim 18.
